(19) United States
(12) Patent Application Publication
(10) Pub. No.: US 2015/0068182 A1
(43) Pub. Date: Mar. 12, 2015

(54) MATERIAL COLLECTION SYSTEM SENSOR

(71) Applicant: DEERE & COMPANY, MOLINE, IL (US)

(72) Inventors: MICHAEL J. DECOSTER, SALISBURY, NC (US); JAMES W. MUSSER, CARY, NC (US)

(73) Assignee: DEERE & COMPANY, MOLINE, IL (US)

(21) Appl. No.: 14/023,961

(22) Filed: Sep. 11, 2013

(51) Int. Cl. A01D 34/00

(52) U.S. Cl. CPC A01D 34/006; A01D 34/001
USPC 56/202

(57) ABSTRACT

A material collection system sensor includes an ultrasonic sensor mounted in a collection container above a discharge chute from a lawn and garden tractor mower deck. The ultrasonic sensor provides data to an electronic control unit representing the distance between a material pile in the collection container and the ultrasonic sensor. The electronic control unit filters out data that fails to meet certain pre-specified criteria and correlates the distance data to a fill level of the collection container. A fill level indicator such as a visual display is connected to the electronic control unit and displays information about any fill level of the collection container.

### FIELD OF THE INVENTION

This invention relates generally to grass mowing machines, and more specifically to material collection system sensors.

### BACKGROUND OF THE INVENTION

Grass mowing machines may include material collection system sensors that are intended to sense if the collection container is full. For example, some material collection systems include sensors that detect air pressure in the discharge chute as shown in U.S. Pat. Nos. 5,388,394, 5,605,033, 5,775,077, 5,950,408, 6,073,4342 and 6,622,465. These sensors do not provide information about partial fill levels of the collection container.

Other material collection system sensors include pivotable devices that contact grass clippings in the container as shown in U.S. Pat. Nos. 4,969,320 and 6,272,818; electrical conductivity sensors as shown in U.S. Pat. Nos. 4,964,266 and 5,960,613 and European Patent Application EP2020173A1; sensors that detect resistance to oscillation as shown in U.S. Pat. No. 5,832,708; light sensors as shown in U.S. Pat. No. 5,321,939; and weight sensors as shown in U.S. Pat. No. 4,981,011. These sensors are not repeatable for wet grass clippings and dry grass clippings.

There is a need for a material collection system sensor that can accurately detect and provide a partial fill level to the operator before the container is full. There is a need for a material collection system sensor that can provide repeatable performance with wet grass clippings and dry grass clippings. There is a need for a material collection system sensor that can help maximize the amount of material collected in the container, without the discharge chute becoming plugged with grass clippings.

### SUMMARY OF THE INVENTION

A material collection system sensor accurately detects and provides the partial fill level to the operator before the container is full, and provides repeatable performance with wet grass clippings and dry grass clippings. The material collection system sensor helps maximize the amount of material collected in the container, without the discharge chute becoming plugged with grass clippings.

The material collection system sensor comprises an ultrasonic sensor mounted above the discharge chute exit in the collection container that provides data regarding the distance to a pile of material in the collection container. A visual display provides fill level information correlating to any distance detected by the ultrasonic sensor.

### BRIEF DESCRIPTION OF THE DRAWINGS

FIG. 1 is a side view, partially in section, of a lawn and garden tractor with the material collection system sensor according to a first embodiment of the invention.

FIG. 2 is a rear perspective view, partially in section, of a lawn and garden tractor with the material collection system sensor according to a preferred embodiment of the invention.

### DESCRIPTION OF THE PREFERRED EMBODIMENT

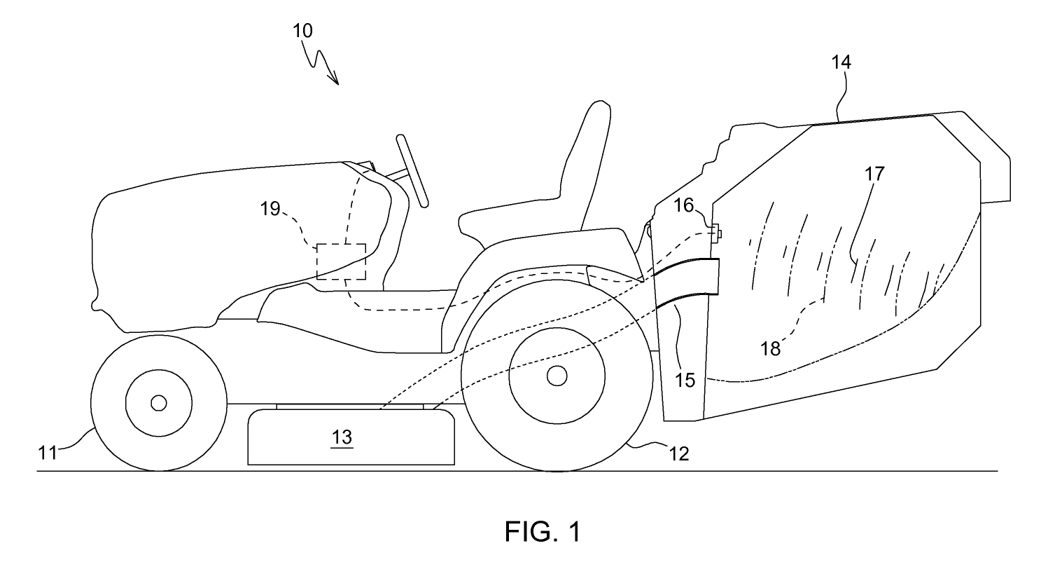

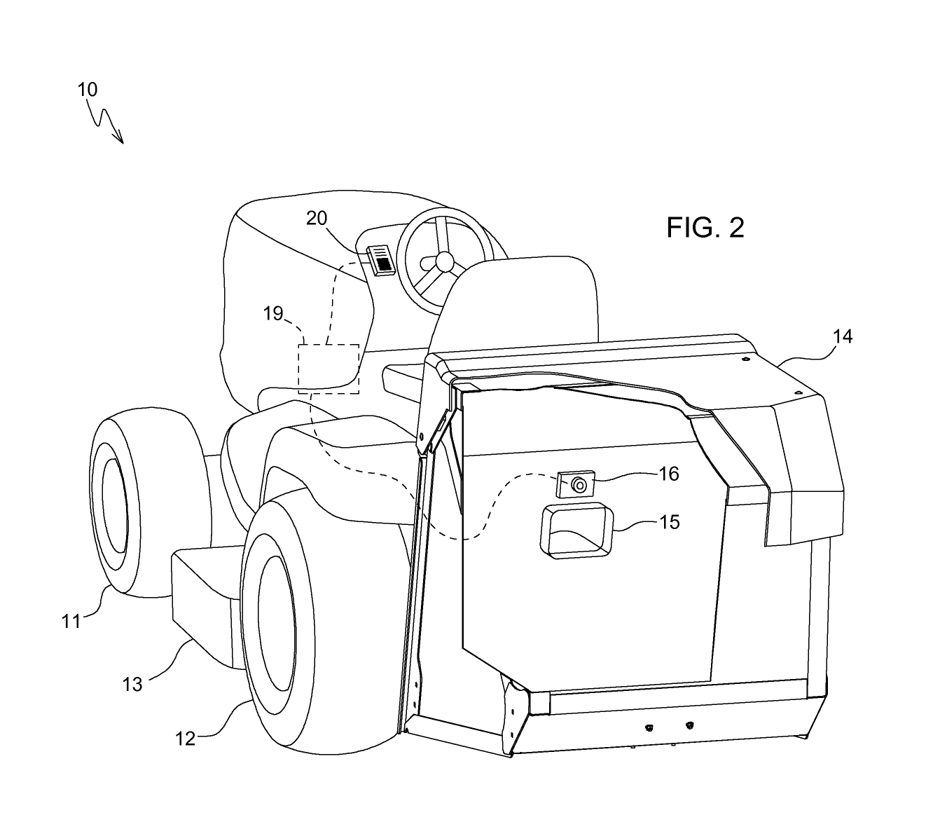

In one embodiment shown in FIGS. 1 and 2, lawn and garden tractor 10 may have front wheels 11, rear wheels 12, mower deck 13 suspended from the vehicle frame between the front and rear wheels, and collection container or hopper 14 mounted at the rear of the vehicle. At least one surface, or a portion of one or more surfaces, of collection container 14 may be an air permeable material, such as a mesh or screen. Mower deck 13 may cover one or more cutting blades to cut and propel grass clippings into a material collection system. The material collection system may include discharge chute 15 extending rearwardly between an opening in mower deck 13 and grass collection container 14. Optionally, the material collection system may include an auxiliary blower or fan which may be mounted in a housing adjacent discharge chute 15 to help propel grass clippings through the duct into grass collection container 14.

In one embodiment, material collection system may be a rear discharge, rear collect configuration. For example, the mower deck may have two counter rotating cutting blades which force the grass clippings through a discharge chute located under the operator's seat. The grass clippings may exit the discharge chute and enter the collection container that the operator may tip and dump from a seated position. The material collection system sensor also may be used on lawn and garden tractors having side discharge decks and/or three or more cutting blades. Additionally, the material collection system sensor may be used on other types of grass mowing machines including but not limited to zero turning radius mowers.

In one embodiment shown in FIGS. 1 and 2, the material collection system sensor may comprise ultrasonic sensor 16. The ultrasonic sensor may be mounted directly above the exit of discharge chute 15 inside collection container 14. The ultrasonic sensor may provide ultrasonic energy bursts 17 directed and pointed toward a portion of the collection container where grass clippings accumulate. For example, the ultrasonic sensor may be directed at the bottom rear corner of the collection container mounted on the rear of the machine. The ultrasonic sensor then may receive a return signal 18 and determine the distance between the sensor and the grass clippings accumulating in the collection container, based on the time from the energy burst until the return signal.

In one embodiment, if collection container 14 is empty, ultrasonic sensor 16 may provide a maximum distance reading. As grass clippings begin to accumulate in the collection container, there is a shorter distance reading between the ultrasonic sensor and the pile of material. As the pile grows and moves closer to the front and/or top of the collection container, the ultrasonic sensor's distance reading may continue to decrease. When the pile of grass clippings finally approaches the discharge chute's exit near the front of the collection container, directly below the ultrasonic sensor, the distance reading will decrease to a minimal value or zero. The ultrasonic sensor may provide consistent distance readings for most material, including wet or dry grass, as the material piles up close to the sensor, and especially as the collection container fills from about 50% to about 100% full.

In one embodiment, the ultrasonic sensor may provide data to microcontroller or electronic control unit 19 which may use a stored algorithm or table to calculate the distance to the clippings pile, and to correlate the distance data to the fill level of the container. Additionally, the controller may use software filters to filter out unwanted data or noise from the ultrasonic sensor to improve accuracy and reliability of the system. For example, the controller may use software filters to distinguish between the flowing material and the material pile by excluding data that does not meet certain pre-specified criteria.

In one embodiment, controller 19 may provide fill level output to fill level indicator 20 which may be a visual display mounted in the lawn and garden tractor operator station, and/or provide other visual or audible signals of the fill level to the operator. The fill level indicator may include information about any partial fill level of the collection container throughout the entire filling, between empty and full, instead of indicating only if the collection container is full.

In one embodiment, a single ultrasonic sensor may be used, having a single crystal to both transmit and receive ultrasonic energy. For example, the Valeo Gen 5.3 ultrasonic sensor may be used, and/or the ultrasonic sensors described in U.S. Pat. No. 8,104,351. Alternatively, a plurality of ultrasonic sensors and/or combinations of ultrasonic sensors may be used.

In one embodiment, the ultrasonic sensor may transmit a series of ultrasonic energy bursts during a first time period, followed by a second time period while it transmits no bursts and the controller processes information received back from the sensor and estimates the fill level of the container. For example, the ultrasonic sensor may transmit approximately 30 energy bursts during a first time period such as one second, followed by a second time period such as one second while the electronic controller processes information from the sensor to estimate the fill level. Thus, the ultrasonic sensor may sample the distance approximately 30 times per second and the controller may process this information to estimate and update a display showing the fill level at a frequency of approximately 2 Hz. The frequency may be higher or lower provided that a sufficient number of samples are obtained during the fill time of the collection container, which typically may be about 10 minutes.

In one embodiment, the controller may determine the time interval Δt as the time between the start of each ultrasonic energy burst and the start of each return signal from that burst. The return signal may be characteristic of the location of the clippings pile or back wall of the container. The controller may use each time measurement Δt to determine the distance from the ultrasonic sensor to the clippings pile or back wall, where distance=0.5*c*Δt, and c=343 m/second @ 20 degrees C. As described below, the controller may filter out echoes or other unwanted return signals that may not be characteristic of the clippings pile or back wall.

In one embodiment, the controller may use one or more filters, filtering techniques, or grouping techniques to the return signals from the ultrasonic sensor. For example, the controller may filter out return signals that represent flying or recirculating debris within the collection container, flying or recirculating debris physically contacting the face of the ultrasonic sensor, echoes from multi-surface reflections within the collection container, or any combination of the above.

For example, the controller may filter out return signals with time measurements Δt that are less than a specified minimum such as 230 μs, and/or greater than a specified maximum such as 450 μs. The controller may filter out return signals with Δt under the minimum because those signals may represent blowing material having less reflective energy than the clippings pile. The controller may filter out return signals with Δt above the maximum because they may indicate distances beyond the container's back wall, or multi-surface reflected echoes. Alternatively, the controller may filter out return signals unless a plurality of return signals with the same or similar time measurements Δt are received back for consecutive ultrasonic energy bursts. For example, the controller may filter out return signals unless time measurements Δt representing distances within 40 mm are received back for 3 consecutive ultrasonic energy bursts. Alternatively, for various time intervals, the controller may group together return signals having the same or similar time measurements Δt, and then select the group representing a fill level having the most return signals. For example, during each one second time interval, the controller may determine if more return signals have time measurements Δt representing a fill level such as 20%, than return signals for any other fill level such as 15% or 30%.

Having described the preferred embodiment, it will become apparent that various modifications can be made without departing from the scope of the invention as defined in the accompanying claims.

1. A material collection system sensor, comprising:
an ultrasonic sensor mounted in a collection container above a discharge chute and directed to a portion of the collection container where a pile of grass clippings accumulates, and providing data to an electronic control unit regarding the distance between the pile and the ultrasonic sensor;
the electronic control unit filtering the data based on certain pre-specified criteria and correlating the distance data to a fill level of the collection container; and
a fill level indicator connected to the electronic control unit and displaying information about any fill level of the collection container.

2. The material collection system sensor of claim 1 wherein the mower deck and collection container are part of a rear discharge rear collection system.

3. A material collection system sensor, comprising:
an ultrasonic sensor in the collection container and providing a series of energy bursts during a first time period, followed by a second time period while an electronic controller processes information from the sensor to estimate the fill level;
a fill level indicator connected to the electronic controller and providing fill level information correlating to the data from the ultrasonic sensor.

4. The material collection system sensor of claim 3 wherein the electronic control unit filtering out certain data from the ultrasonic sensor.

5. The material collection system sensor of claim 3 wherein the ultrasonic sensor is mounted directly above a discharge chute into the collection container and is directed toward a bottom rear corner of the collection container.

6. A material collection system sensor, comprising:
an electronic control unit connected to an ultrasonic sensor and a fill level indicator;
the electronic control unit receiving data from the ultrasonic sensor and filtering out certain data that does not meet pre-specified criteria and using the remaining data to cause the fill level indicator to display any fill level of grass clippings in a material collection container between empty and full.

7. The material collection system sensor of claim 6 wherein the ultrasonic sensor is mounted above a discharge chute into the material collection container.

8. The material collection system sensor of claim 6 wherein the ultrasonic sensor is directed to a bottom corner of the material collection container.

9. The material collection system sensor of claim 6 wherein the electronic control unit filters out data from the ultrasonic sensor that is below a minimum time and distance.

10. The material collection system sensor of claim 6 wherein the electronic control unit filters out data from the ultrasonic sensor that is over a maximum time and distance.

11. The material collection system sensor of claim 6 wherein the electronic control unit filters out data from the ultrasonic sensor that is not one of a plurality of consecutive data having the same or similar time and distance measurement.

12. The material collection system sensor of claim 6 wherein the electronic control unit groups together data having the same or similar time and distance measurements and then selects the group with the most data.
